(19) United States
(12) Patent Application Publication
(10) Pub. No.: US 2023/0132696 A1
(43) Pub. Date: May 4, 2023

(54) SMART DOORBELL SYSTEM

(71) Applicant: THOMAS IDOWU BANJO, SAN ANTONIO, TX (US)

(72) Inventor: THOMAS IDOWU BANJO, SAN ANTONIO, TX (US)

(21) Appl. No.: 17/749,409

(22) Filed: May 20, 2022

Related U.S. Application Data
(60) Provisional application No. 63/193,348, filed on May 26, 2021.

(51) Int. Cl. G06Q 10/0833; G08B 13/196

(52) U.S. Cl. CPC G06Q 10/0833; G08B 13/1966

(57) ABSTRACT

In one aspect, a computerized smart doorbell method comprising: with at least one server of a merchant electronics data interchange (EDI) system: sending a first electronic communication to a destination customer smartphone, wherein the first electronic communication comprises one or more authentication items comprising an order tracking number and a delivery personnel identifier ID; and sending a second electronic communication comprising the order ID, an item ID and an estimated time of delivery to a logistics entity server-side system; detecting that a delivery entity related to the logistics entity has arrived with the item at an address of the destination customer; with a delivery-side handheld scanning application in a delivery entity mobile device managed by the logistics entity server-side system, scanning an anti-theft tag located on a package of the item; automatically sending a delivery personnel ID and a delivery tracking number of the item to the EDI system from the delivery-side handheld scanning application in a third electronic communication; detecting the delivery personnel ID matches with the order ID; with the destination customer smartphone, activating the smart doorbell system to send the address of the destination customer to the delivery-side handheld scanning application via the EDI system in a fourth electronic communication; with the delivery-side handheld scanning application implementing a near field communication (NFC) handshaking operation between the delivery-side handheld scanning application and the smart doorbell system; with the smart doorbell system, obtaining the address of the destination customer and sending the address of the destination customer to the merchant EDI system with a fifth electronic communication; with the merchant EDI system, receiving the address of the destination customer from the fifth electronic communication and validating that the item has been delivered to address of the destination customer; with the delivery-side mobile device, implementing a second handshake, wherein the second handshake comprises sending a JSON message to the smart doorbell system with an instruction to take a digital picture of the item in a delivered state and the digital picture of the item is electronically communicated in a sixth electronic communication as a proof of delivery the EDI system; and with EDI system, sending a seventh electronic communication to the destination customer smartphone and the delivery entity mobile device, wherein the seventh electronic communication comprise a text message stating success of the delivery of the item at the destination address.

### CLAIM OF PRIORITY

This application claims priority to United States Provisional Application No. 63/193,348, filed on 26 May 2021 and titled Smart Autonomous Last Mile Delivery Solution. This provisional application is incorporated herein by reference in its entirety.

### FIELD OF INVENTION

This invention related to smart doorbell systems, and more specifically for smart doorbell based autonomous last mile delivery solution.

### BACKGROUND

Currently, around fifteen percent (15%) of online deliveries are either lost or stolen each day in the US. Present solutions are fragmented and rely on individual steps and a human intervention to provide continuity in the supply chain process. Moreover, some of the devices leveraged for deliveries are designed for standalone operations which can be disconnected from the last mile delivery process. Current solutions also utilize inadequate logging of the movement of packages and goods. The present lack of machine-to-machine communication to implement tracking and communication leaves the current systems susceptible to failure. Accordingly, improvements to last mile tracking and verification of deliveries (and returns) are desired.

### SUMMARY OF THE INVENTION

In one aspect, a computerized smart doorbell method comprising: with at least one server of a merchant electronics data interchange (EDI) system: sending a first electronic communication to a destination customer smartphone, wherein the first electronic communication comprises one or more authentication items comprising an order tracking number and a delivery personnel identifier ID; and sending a second electronic communication comprising the order ID, an item ID and an estimated time of delivery to a logistics entity server-side system; detecting that a delivery entity related to the logistics entity has arrived with the item at an address of the destination customer; with a delivery-side handheld scanning application in a delivery entity mobile device managed by the logistics entity server-side system, scanning an anti-theft tag located on a package of the item; automatically sending a delivery personnel ID and a delivery tracking number of the item to the EDI system from the delivery-side handheld scanning application in a third electronic communication; detecting the delivery personnel ID matches with the order ID; with the destination customer smartphone, activating the smart doorbell system to send the address of the destination customer to the delivery-side handheld scanning application via the EDI system in a fourth electronic communication; with the delivery-side handheld scanning application implementing a near field communication (NFC) handshaking operation between the delivery-side handheld scanning application and the smart doorbell system; with the smart doorbell system, obtaining the address of the destination customer and sending the address of the destination customer to the merchant EDI system with a fifth electronic communication; with the merchant EDI system, receiving the address of the destination customer from the fifth electronic communication and validating that the item has been delivered to address of the destination customer; with the delivery-side mobile device, implementing a second handshake, wherein the second handshake comprises sending a JSON message to the smart doorbell system with an instruction to take a digital picture of the item in a delivered state and the digital picture of the item is electronically communicated in a sixth electronic communication as a proof of delivery the EDI system; and with EDI system, sending a seventh electronic communication to the destination customer smartphone and the delivery entity mobile device, wherein the seventh electronic communication comprise a text message stating success of the delivery of the item at the destination address.

### BRIEF DESCRIPTION OF THE DRAWINGS

The present application can be best understood by reference to the following description taken in conjunction with the accompanying figures, in which like parts may be referred to by like numerals.

FIG. 1 illustrates an example smart-tracking and notification system, according to some embodiments.

FIG. 2 illustrates an example process for smart-tracking and notification, according to some embodiments.

FIG. 3 illustrates an example process for implementing smart doorbell tracking and verification, according to some embodiments.

FIG. 4 illustrates an example process for automated delivery smart-tracking and notification, according to some embodiments.

FIG. 5 illustrates an example process for implementing returns, according to some embodiments.

FIG. 6 illustrates an example process for implementing anti-theft protection, according to some embodiments.

FIG. 7 illustrates an example process for making a smart-tracking and notification system, according to some embodiments.

FIG. 8 illustrates an example process for using a smart-tracking and notification system, according to some embodiments.

FIG. 9 depicts an exemplary computing system that can be configured to perform any one of the processes provided herein.

The Figures described above are a representative set and are not an exhaustive with respect to embodying the invention.

### DESCRIPTION

Disclosed are a system, method, and article of manufacture for an autonomous last mile delivery solution. The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Bluetooth is a wireless technology standard used for exchanging data between fixed and mobile devices over short distances using short-wavelength UHF radio waves in the industrial, scientific, and medical radio bands, from 2.402 GHz to 2.480 GHz, and building personal area networks (PANS).

Electronic data interchange (EDI) is the concept of businesses electronically communicating information that was traditionally communicated on paper, such as purchase orders and invoices.

Geofence is a virtual perimeter for a real-world geographic area. A geo-fence could be dynamically generated (e.g. as in a radius around a point location) or match a predefined set of boundaries (such as a home's curtilage, neighborhood boundaries, zone around a business, zone around a doorway, etc.). Geofencing can include a location-aware device of a location-based service (LBS) that is aware of users/objects entering or exiting a geo-fence. This activity can trigger various actions provided herein (e.g. an alert to the device's user as well as messaging to the geo-fence operator, etc.).

Near-field communication (NFC) is a set of communication protocols that enables communication between two electronic devices over a distance of 4 cm (11/2 in) or less.

Radio-frequency identification (RFID) uses electromagnetic fields to automatically identify and track tags attached to objects. An RFID system consists of a tiny radio transponder, a radio receiver and transmitter. When triggered by an electromagnetic interrogation pulse from a nearby RFID reader device, the tag transmits digital data, usually an identifying inventory number, back to the reader. An inventory number can be used to track inventory goods.

Scanners can include image scanners that digitize two-dimensional images. As used herein a scanner can also include a 3D scanner, which digitizes the three-dimensional shape of a real object. Scanners can be barcode scanners, laser scanners, etc. as well. In some examples, it is noted that a scanner can also include an NFC-based scanner that implements a handshake and exchange of data between two or more physical devices.

### EXAMPLE METHODS

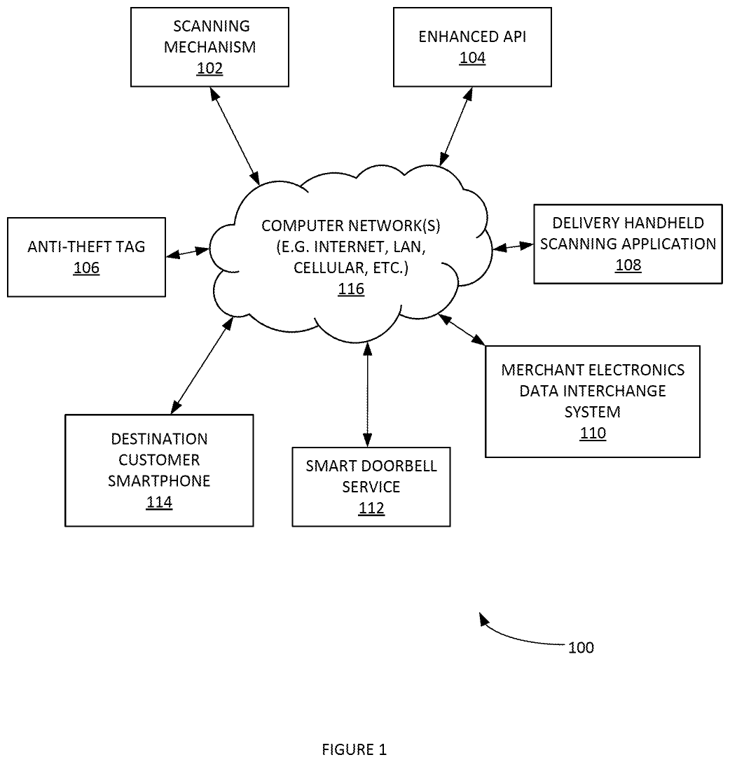

FIG. 1 illustrates an example smart-tracking and notification system 100, according to some embodiments. Smart-tracking and notification system 100 can provide an end-to-end machine to machine communication between hardware devices, middleware cloud server hosted platforms, end user notification, authentication, and visibility. Smart-tracking and notification system 100 can use a novel authentication method and transparency built into the solution from start to completion. As discussed infra, smart-tracking and notification system 100 can integrate with existing smart doorbells and/or other service providers at the client side and barcode scanners (e.g. of delivery personnel) and merchant electronic data interchange system. Smart-tracking and notification system 100 can provide a machine-to-machine communication between hardware devices, middleware cloud server hosted platforms, end-user notification, authentication, and visibility.

Smart-tracking and notification system 100 can include an enhanced smart doorbell with a scanning mechanism 102. Scanning mechanism 102 can be a computer input device that obtains digital images and/or other digitized information. Scanning mechanism 102 can include, inter alia: digital cameras, flatbed scanners, sheet fed scanners, print- head scanners and hand-held scanners, laser scanners, various hand-held scanners, various bar-code scanners, etc.

Smart-tracking and notification system 100 can include an enhanced API(s) 104. Enhanced API(s) 104 can be used to communicate between merchant data systems, delivery scanners, doorbell service provider, and/or customer (smart)phones.

Smart-tracking and notification system 100 can include an anti-theft tag 106. Anti-theft tag 106 can include programmable geo-fencing functionalities and start-time initiation functionalities.

Smart-tracking and notification system 100 can include a delivery handheld scanning application 108. Handheld scanning application 108 can be implemented from a handheld-scanning device, smartphone system with scanning application, etc.

Smart-tracking and notification system 100 can include a merchant electronics data interchange system 110. Merchants electronics data interchange system 110 can include and/or communicate with various data processing systems, including, inter alia: online transaction processing, electronic data interchange (EDI), inventory management systems, and automated data collection systems.

Smart-tracking and notification system 100 can include a smart doorbell service 112. Smart doorbell service 112 can be an Internet-connected doorbell that notifies the smartphone or other electronic device of the homeowner (and/or business owner, etc.) when a delivery person (and/or other type of visitor) arrives at the door. It activates when the visitor presses the button of the doorbell and/or alternatively when the doorbell senses a visitor with its built-in motion sensors. The smart doorbell can notify the homeowner use a smartphone application to watch and talk with the visitor by using the doorbell's built-in high-definition infrared camera and microphone. Smart doorbells can be either battery operated or wired. Some smart doorbells also allow the user to open the door remotely using a smart lock.

A smart lock can be an electromechanical lock which is designed to perform locking and unlocking operations on a door when it receives such instructions from an authorized device using a wireless protocol and a cryptographic key to execute the authorization process. It can also monitor access and send alerts (e.g. text messages, emails, MMS, push notifications, etc.) for the different events it monitors and some other critical events related to the status of the device. Smart locks can be considered part of a smart home. It is noted that smart-tracking and notification system 100 can be integrated into a smart home system (and/or smart business building system).

Smart-tracking and notification system 100 can include destination customer smartphone 114. Destination customer smartphone 114 can receive messages/updates from the other elements of smart-tracking and notification system 100.

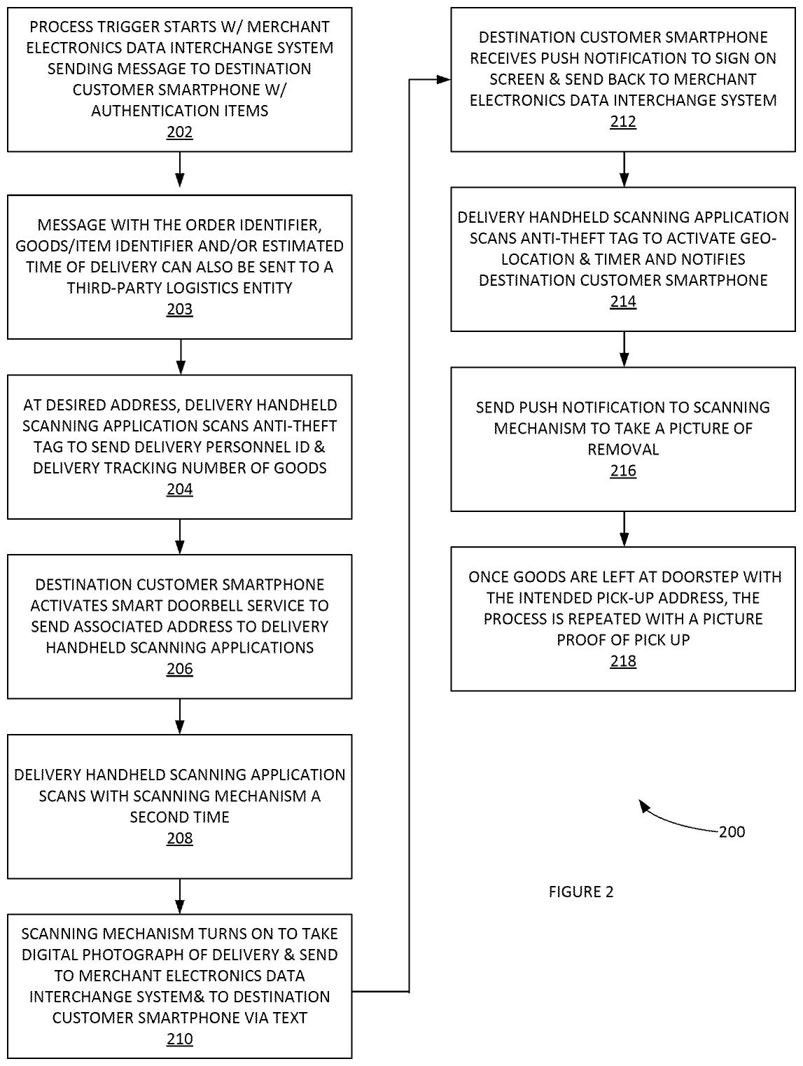

FIG. 2 illustrates an example process 200 for smart-tracking and notification, according to some embodiments. In step 202, the process trigger starts with merchant electronics data interchange system 110 sending a message to destination customer smartphone 114 with authentication items (e.g. tracking number and delivery personnel ID, etc.). A message with the order identifier, goods/item identifier and/or estimated time of delivery can also be sent to a third-party logistics entity in step 203. It is noted that when a customer buys an item on a merchant portal there is a confirmation provided. This confirmation includes an order identifier, etc. The merchant then sends this information to a third-party logistics company that uses order identifier, intended delivery date and goods/item information. The third-party logistic entity then sends goods/items, shipping date and tracking number to step 204.

In step 204, upon arrival at the desired address, delivery handheld scanning application 108 scans anti-theft tag 106 to send the delivery personnel ID and the delivery tracking number of the goods. It is noted that in step 204, at destination address, process 200 can enable a scanning of labels of an anti-theft code and/or a shipping code on the item package.

In step 206, once the ID matches with the pre-sent ID, destination customer smartphone 114 activates smart doorbell service 112 to send the associated address to delivery handheld scanning application 108 via merchant electronics data interchange system 110. Step 206 can be implemented between an NFC handshaking operation between the deliver person's mobile device/smart phone and the smart doorbell. The delivery person can place the mobile device/smart phone by smart doorbell and an NFC pairing is performed. During the scan, the smart doorbell fetches the order identifier and tracking number. These are transmitted from the delivery-side mobile device/smart phone to smart doorbell and the smart-door bell service provider. The smart doorbell then picks up associated home address and sends it to the merchant EDI portal. The merchant EDI portal has the intended address so can validate the delivered to address and if no match then the merchant EDI portal notify delivery person that the package is at wrong address. If there is a match, then (e.g. see step 210) the delivery-side mobile device/smart phone does a second handshake where it sends out JSON message to the smart doorbell to take a digital picture of the delivery (e.g. the package on the porch, etc.) and proof of delivery is sent to merchant portal who then sends to intended customer and delivery guys phone stating success of delivery.

In step 208, if the returned address matches with the destination address on delivery handheld scanning application 108, delivery handheld scanning application 108 scans with scanning mechanism 102 a second time. In step 210, on this scan, scanning mechanism 102 turns on to take a digital photograph of the delivery and send to merchant electronics data interchange system 110 as well as send to destination customer smartphone 114 via text to complete the proof of delivery. In step 212, If the delivery requires a signature proof, destination customer smartphone 114 receives a push notification to sign on screen and send back to merchant electronics data interchange system 110. In step 214, if the goods contain an anti-theft feature, delivery handheld scanning application 108 scans anti-theft tag 106 to activate the geo-location and timer and notifies destination customer smartphone 114 via an instruction to scan anti-theft tag 106 before picking up using a present link to phone camera scanning. In step 216, if not scanned, it can send a push notification to scanning mechanism 102 to take a picture (e.g. a digital photograph) of the removal. In step 218, for returns, once goods are left at doorstep with the intended pick-up address, the process is repeated with a picture proof of pick up.

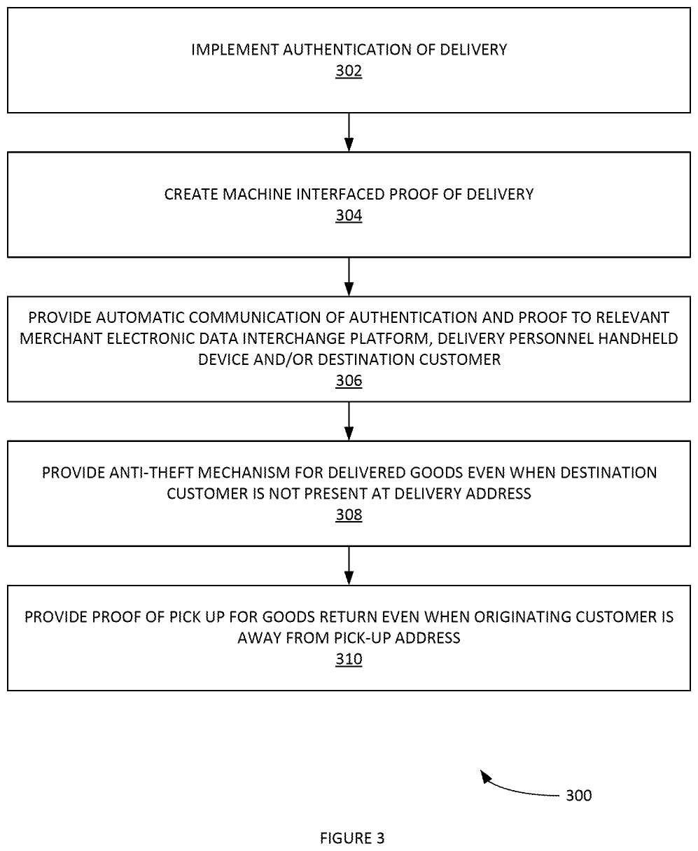

FIG. 3 illustrates an example process 300 for implementing smart doorbell tracking and verification, according to some embodiments. In step 302, process 300 can implement authentication of the delivery. In step 304, process 300 can create a machine interfaced proof of delivery. In step 306, process 300 can provide an automatic communication of the authentication and proof to the relevant merchant electronic data interchange platform, delivery personnel handheld device and/or the destination customer. In step 308, process 300 can create an anti-theft mechanism for delivered goods even when the destination customer is not present at the delivery address. In step 310, process 300 can provide proof of pick up for goods return even when the originating customer is away from the pick-up address.

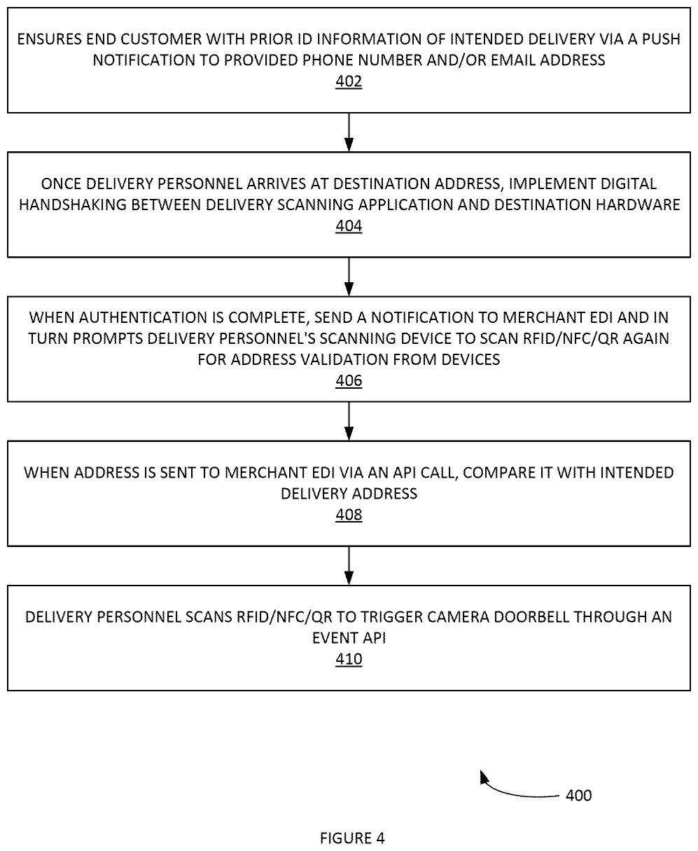

FIG. 4 illustrates an example process 400 for automated delivery smart-tracking and notification, according to some embodiments. In step 402, process 400 ensures end customer with prior ID information of the intended delivery via a push notification to the provided phone number and/or email address. In step 404, process 400 can, once the delivery personnel arrives at the destination address, implement a digital handshaking between the delivery scanning application and the destination hardware. For example, an RFID/NFC/QR operation can send a predefined API with ID and tracking number of the goods being delivered for customer authentication as a push button authorize option Yes/No.

In step 406, process 400 can, when the authentication is complete, send a notification to merchant EDI and in turn prompts the delivery personnel's scanning device to scan the RFID/NFC/QR again for address validation from the devices. In step 408, process 400 can, when the address is sent to the merchant EDI via an API call, compare it with the intended delivery address. If it matches, the merchant API sends the confirmation to the delivery personnel's scanner application to proceed to step 410.

In step 410, the delivery personnel can scan the RFID/NFC/QR to trigger the camera doorbell through an event API. The delivery personnel can take a digital picture. Process 400 can push a signature proof requirement to the customer's phone (e.g. if required) to gather the signature.

In step 410, on receipt of the photo and signature (e.g. if required), process 400 can send the gathered information to the merchant EDI platform as well as to the customer's phone number with the delivery proof including date, time, digital photograph, and signature. With this the delivery personnel scanner can be notified that the delivery is complete.

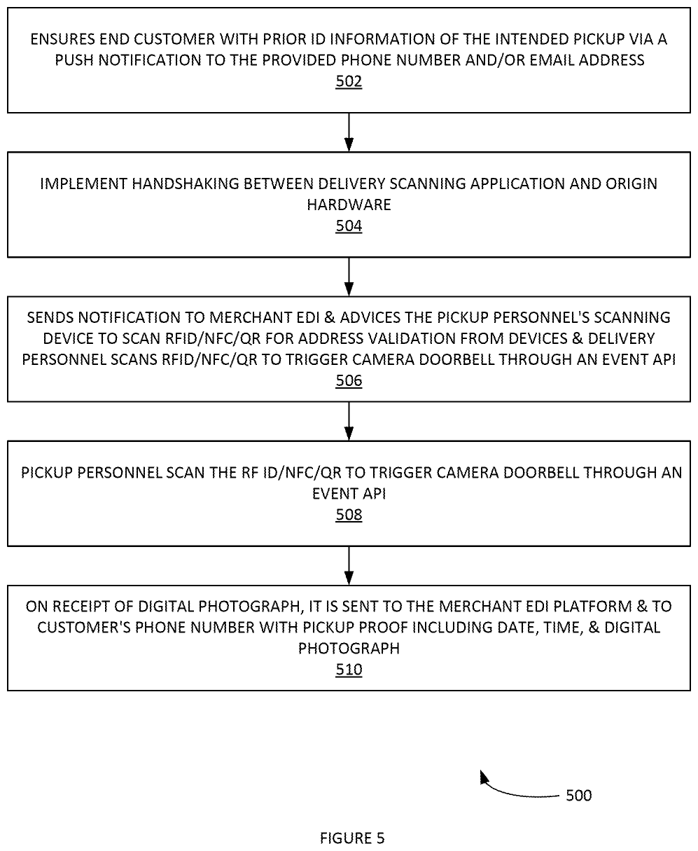

FIG. 5 illustrates an example process 500 for implementing returns, according to some embodiments. Prior to initiating process 500, a customer can provide a merchant portal (e.g. a merchant EDI system) the product identifier, the order identifier, the pickup address, the time (e.g. a time range) of pick up (e.g. when and where the return package will be available for pick up, etc.), and/or other relevant information. The merchant portal can also enable the customer to generate a return label and a return tracking identifier. The merchant EDI system initiates the return process by contacting the third-party logistics entity. The merchant EDI system provides the third-party logistics entity the relevant return process data as well.

In some embodiments, the delivery driver then arrives at the address. The mobile device/smartphone application, the delivery driver performs and NFC handshake with the smart doorbell. If a matches happens, the merchant EDI system then pushes instructions to the mobile device/smartphone application as to the steps to remove/scan the return package. Optionally, it is the deliver driver who can then print the return shipping label and apply to the return package and scan it. The deliver driver can then use the mobile device/smartphone application to initiate a proof of pick up via another NFC handshake with the smart doorbell. The smart doorbell implements a digital picture/video of the deliver driver taking the return package as proof of return. The proof of pickup is sent to the smart doorbell system that then sends it to the merchant EDI system and the customer as proof of pickup. The proof of pick-up data can be stored in various databases.

In step 502, process 500 can ensure an end customer with prior ID information of the intended pickup via a push notification to the provided phone number and/or email address. In step 504, once the pickup personnel arrives at the origin address, process 500 can implement the handshaking between the delivery scanning application and the origin hardware. For example, process 500 can use the RFID/NFC/QR operation to send a predefined API with ID and tracking number of the goods being picked up for customer authentication as a push button authorize option Yes/No.

In step 506, when the authentication is complete, process 500 sends a notification to merchant EDI and in turn advices the pickup personnel's scanning device to scan the RFID/NFC/QR again for address validation from the devices. In step 506, when the address is sent to the merchant EDI via an API call, it is compared with the intended pickup address. If it matches, the merchant API sends the confirmation to the pickup personnel's scanner application to proceed to step 508.

In step 508, the pickup personnel can scan the RF ID/NFC/QR to trigger the camera doorbell through an event API which will take a picture. In step 510, on receipt of the digital photograph, it is sent to the merchant EDI platform as well as to the customer's phone number with the pickup proof including date, time, and digital photograph.

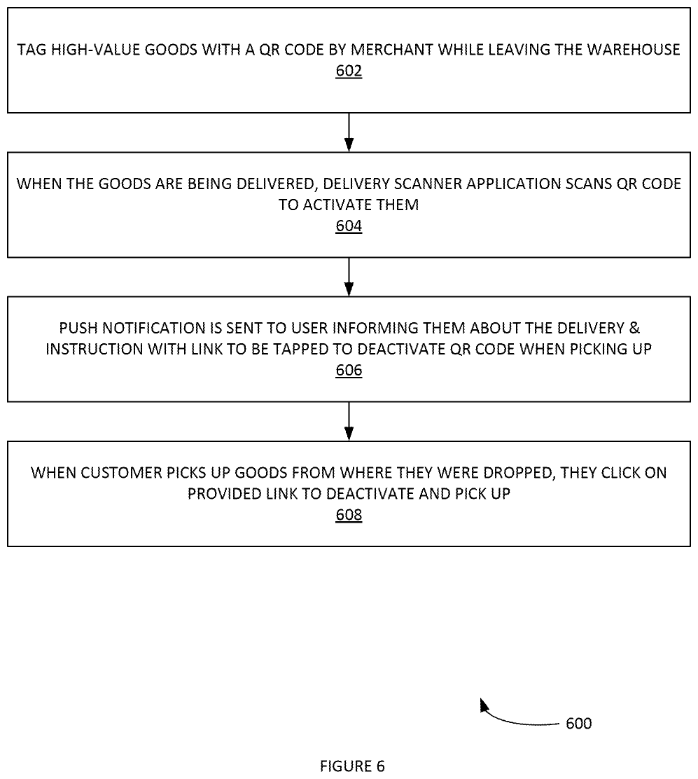

FIG. 6 illustrates an example process 600 for implementing anti-theft protection, according to some embodiments. In step 602, process 600 tags high-value goods with a QR Code (and/or other matrix code) by the merchant while leaving the warehouse. In step 604, when the goods are being delivered, the delivery scanner application scans the QR code to activate them. At which point the QR code is programmed with the location and the active status ON.

In step 606, on activating the QR code, a push notification is sent to the user informing them about the delivery and an instruction with a link to be tapped to deactivate the QR code when picking up. In step 608, when customer picks up the goods from where they were dropped, they click on the provided link to deactivate and pick up.

It is noted that in some examples, an RFID label (e.g. a passive RFID tag) can be added to the package as well. This is scanned by the delivery driver. The customer then receives a hyperlink. Opening the hyperlink enables the customer to scan with the mobile device/smartphone the same RFID tag with the mobile device/smartphone application. If there is a match, then the passive RFID tag deactivates. If it is moved (e.g. from the delivery lat/long, etc.) without deactivation, the RFID causes an alarm to be sounded (e.g. an alert to customer, etc.).

Process 600 can implement the following algorithms as well. If delivery personnel ID and the tracking number match the previously sent ID by merchant electronics data interchange system 110, then destination customer smartphone 114 confirms. Smart doorbell service 112 sends address associated with doorbell to delivery handheld scanning application 108 via merchant electronics data interchange system 110.

If address returned matches delivery address, merchant electronics data interchange system 110 shows matched notification on delivery handheld scanning application 108. Otherwise, if else, then process 600 returns a wrong address and exits. If they are matched, then delivery handheld scanning application 108 scans (e.g. with scanning mechanism 102) to trigger an event in scanning mechanism 102 for a digital photograph capture of delivery item.

If the digital photograph is captured and no signature proof required, then process 600 uses enhanced API(s) 104 to push proof of delivery to merchant electronics data interchange system 110 and destination customer smartphone 114. Else, process 600 pushes notification to destination customer smartphone 114 to enter signature and then sends the digitized signature together with the capture digital photograph to merchant electronics data interchange system 110 and destination customer smartphone 114.

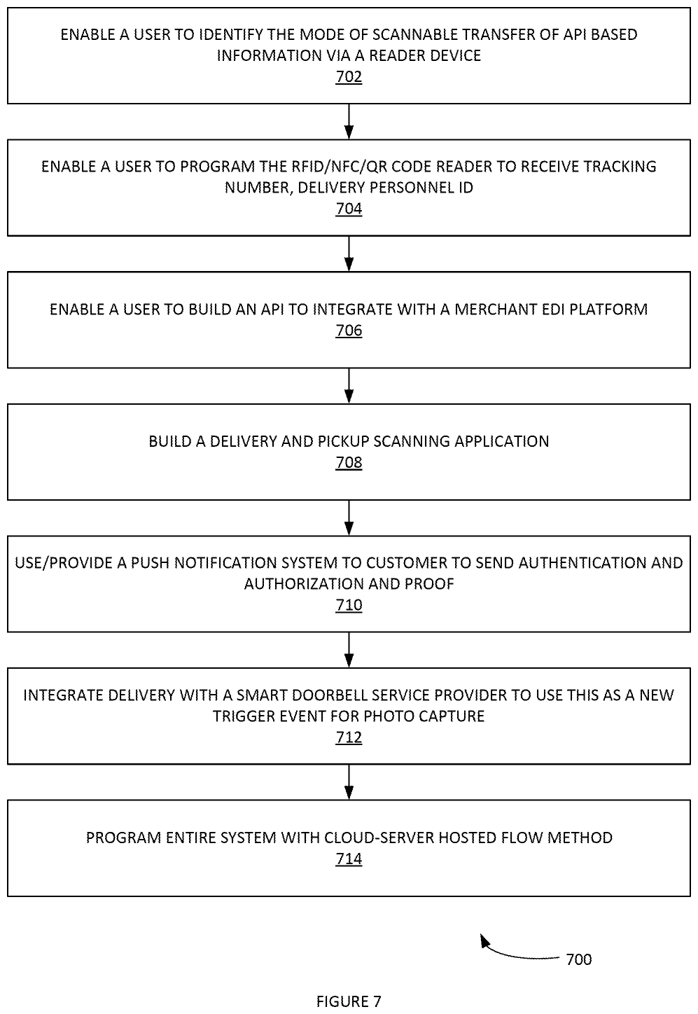

FIG. 7 illustrates an example process 700 for making a smart-tracking and notification system 100, according to some embodiments. In step 702, process 700 enables a user to identify the mode of scannable transfer of API based information via a reader device (e.g. RFID reader, NFC reader, and/or QR Code reader).

In step 704, process 700 enables a user to program the RFID/NFC/QR Code reader to receive tracking number, delivery personnel ID. In step 706, process 700 enables a user to build an API to integrate with a merchant EDI platform.

Process 700 can use various input fields. These can include, inter alia: tracking number, assigned delivery person photo id, customer provided address, conditional check for provided address vs destination address for the tracking number, signature proof, photo proof, anti-theft QR code ID, customer authentication Yes/No.

In step 708, process 700 can build a delivery and pickup scanning application with the following features:

(1) Connected to the Merchant Server via an API; and/or

(2) Transmit the API with Tracking Number, Delivery Personnel Photo ID, Display of Steps for delivery with proof and pick up with proof, activation of Anti-Theft QR Code with Time Stamp and Geolocation.

In step 710, process 700 can use/provide a push notification system to customer to send authentication and authorization and proof. In step 712, process 700 can integrate delivery with a smart doorbell service provider to use this as a new trigger event for photo capture.

In step 714, process 700 can program the entire system with a cloud-server hosted flow method that algorithmically binds the scan reader, customer smart phone, smart doorbell service provider portal, merchant EDI portal and delivery/pickup scanning application.

Optionally, process 700 can provide an anti-theft QR code (and/or other type of matrix code). The use of the anti-theft QR Code adds security to high value goods which can be leveraged to prevent theft and benefit merchants and insurance companies. In one embodiments, the following elements may be used by process 700, including, inter alia: a code reader, scanning application, a merchant EDI API, smart doorbell service provider API, etc. (e.g. these can be provided by smart-tracking and notification system 100, etc.). In some examples, when a smart doorbell system is not available during delivery, the delivery personnel's mobile phone can be used to take the photo and send to the customer-side application upon completely of the authentication process.

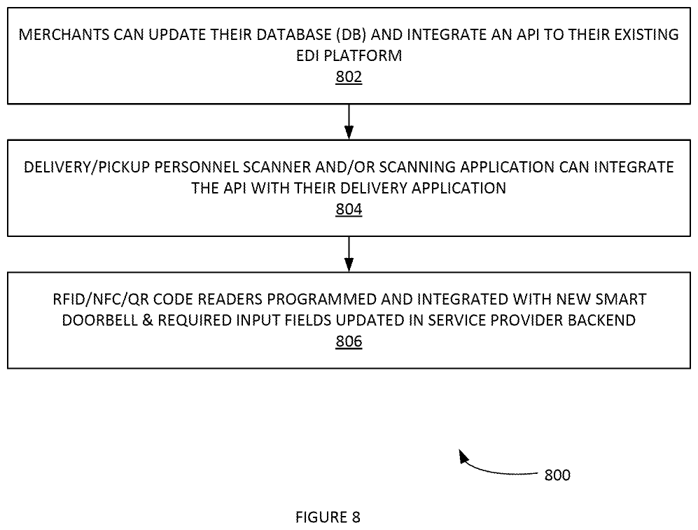

FIG. 8 illustrates an example process 800 for using a smart-tracking and notification system 100, according to some embodiments. In step 802, merchants can update their database (DB) and integrate an API to their existing EDI platform. In step 804, delivery/pickup personnel scanner and/or scanning application can integrate the API with their delivery application to facilitate this invention. In step 806, RFID/NFC/QR Code readers can be programmed and integrated with a new smart doorbell and the required input fields can be updated in the service provider backend.

Process 800 can be used in asset tracking for freights or ports/airports/warehouses. Process 800 be used in other places like secure public lockers, car rental, parking kiosks etc. In this way, the smart doorbell system can be integrated RFID/NFC reader and a backend service provider application that includes the secure delivery fields. Process 800 can use a client-side scanning application (e.g. within a user-side system). Process 800 also provide an RFID scanner capability in smartphones.

Processes 200-800 can be used by smart-tracking and notification system 100 to implement an autonomous last mile delivery solution. Computing system 900 (discussed infra) can be used to implement various elements of smart-tracking and notification system 100.

### EXAMPLE COMPUTING SYSTEMS

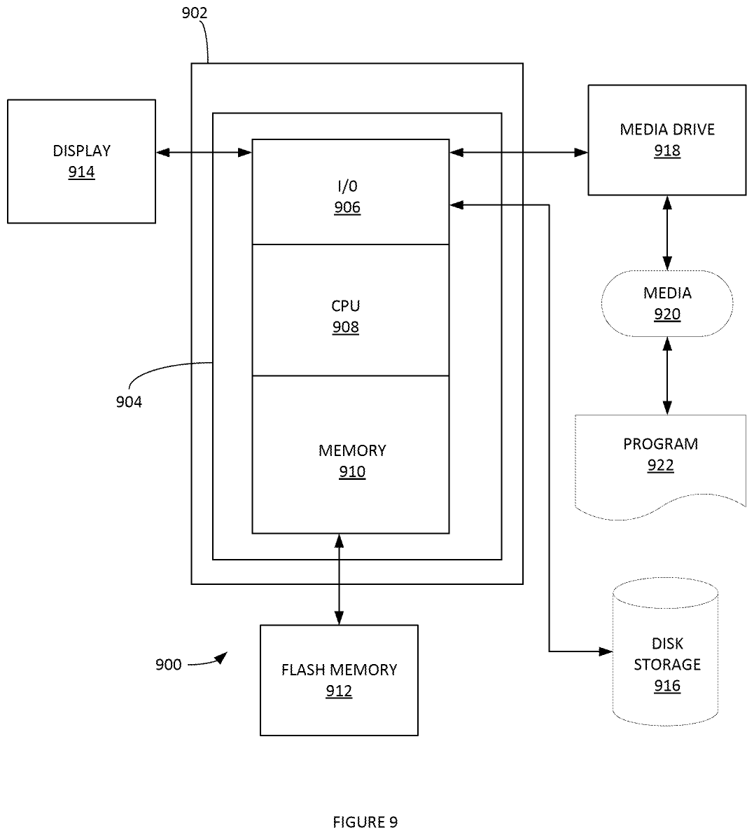

FIG. 9 depicts an exemplary computing system 900 that can be configured to perform any one of the processes provided herein. In this context, computing system 900 may include, for example, a processor, memory, storage, and I/O devices (e.g., monitor, keyboard, disk drive, Internet connection, etc.). However, computing system 900 may include circuitry or other specialized hardware for carrying out some or all aspects of the processes. In some operational settings, computing system 900 may be configured as a system that includes one or more units, each of which is configured to carry out some aspects of the processes either in software, hardware, or some combination thereof.

FIG. 9 depicts computing system 900 with a number of components that may be used to perform any of the processes described herein. The main system 902 includes a motherboard 904 having an I/O section 906, one or more central processing units (CPU) 908, and a memory section 910, which may have a flash memory card 912 related to it. The I/O section 906 can be connected to a display 914, a keyboard and/or other user input (not shown), a disk storage unit 916, and a media drive unit 918. The media drive unit 918 can read/write a computer-readable medium 920, which can contain programs 922 and/or data. Computing system 900 can include a web browser. Moreover, it is noted that computing system 900 can be configured to include additional systems in order to fulfill various functionalities. In another example, computing system 900 can be configured as a mobile device and include such systems as may be typically included in a mobile device such as GPS systems, gyroscope, accelerometers, cameras, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

1. A computerized smart doorbell method comprising:
with at least one server of a merchant electronics data interchange (EDI) system:
sending a first electronic communication to a destination customer smartphone, wherein the first electronic communication comprises one or more authentication items comprising an order tracking number and a delivery personnel identifier ID; and
sending a second electronic communication comprising the order ID, an item ID, and an estimated time of delivery to a logistics entity server-side system;
detecting that a delivery entity related to the logistics entity has arrived with the item at an address of the destination customer;
with a delivery-side handheld scanning application in a delivery entity mobile device managed by the logistics entity server-side system, scanning an anti-theft tag located on a package of the item;
automatically sending a delivery personnel ID and a delivery tracking number of the item to the EDI system from the delivery-side handheld scanning application in a third electronic communication;
detecting the delivery personnel ID matches with the order ID;
with the destination customer smartphone, activating the smart doorbell system to send the address of the destination customer to the delivery-side handheld scanning application via the EDI system in a fourth electronic communication;
with the delivery-side handheld scanning application implementing a near field communication (NFC) handshaking operation between the delivery-side handheld scanning application and the smart doorbell system;
with the smart doorbell system, obtaining the address of the destination customer and sending the address of the destination customer to the merchant EDI system with a fifth electronic communication;
with the merchant EDI system, receiving the address of the destination customer from the fifth electronic communication and validating that the item has been delivered to address of the destination customer;
with the delivery-side mobile device, implementing a second handshake, wherein the second handshake comprises sending a JSON message to the smart doorbell system with an instruction to take a digital picture of the item in a delivered state and the digital picture of the item is electronically communicated in a sixth electronic communication as a proof of delivery the EDI system; and
with EDI system, sending a seventh electronic communication to the destination customer smartphone and the delivery entity mobile device, wherein the seventh electronic communication comprise a text message stating success of the delivery of the item at the destination address.

2. The computerized smart doorbell method of claim 1 further comprising:
with the merchant EDI system, detected that the address of the destination customer matches with a destination address of the order of the item.

3. The computerized smart doorbell method of claim 2 further comprising:
with the delivery handheld scanning application, taking another digital photograph of the item in the delivered state, and sending the second picture in an eight electronic communication to the merchant EDI system to the destination customer smartphone as a complete the proof of delivery.

4. The computerized smart doorbell method of claim 3, wherein the delivery requires a digital signature proof by the destination customer.

5. The computerized smart doorbell method of claim 4, wherein the destination customer smartphone receives a push notification to sign on a touch screen destination customer smartphone.

6. The computerized smart doorbell method of claim 5, wherein the destination customer smartphone sends the digitized signature to the merchant EDI system.

7. The computerized smart doorbell method of claim 6, wherein the delivery-side handheld scanning application scans the anti-theft tag on the packaging of the item to activate a geo-location and timer system.

8. The computerized smart doorbell method of claim 7, wherein the delivery-side handheld scanning application notifies destination customer smartphone via an instruction to scan the anti-theft tag before picking up using a hyperlink with a digital phone camera.

9. The computerized smart doorbell method of claim 7, wherein when the anti-theft tag In step is detected to not be scanned, and wherein another push notification is sent to a scanning mechanism to take a picture of the removal of the item.

10. The computerized smart doorbell method of claim 7, wherein for a return of the item process, once the item is picked up from a doorway of the intended pick-up address, the process is repeated with a picture proof of pick up.

11. The computerized smart doorbell method of claim 1, wherein if there is no match between the customer address from the order of the item and the destination customer address then the merchant EDI portal notifies the delivery person that the package is at wrong address.

12. The computerized smart doorbell method of claim 1, wherein the delivery entity mobile device comprises an NFC system.

13. The computerized smart doorbell method of claim 12, wherein the smart doorbell system comprises another NFC system.

14. The computerized smart doorbell method of claim 1, wherein the delivered state comprises the item package being located on in a doorway area of the destination address

15. The computerized smart doorbell method of claim 1, where the delivery person places the mobile device by the smart doorbell system and an NFC pairing is performed.

16. The computerized smart doorbell method of claim 15, wherein the NFC scan, the smart doorbell system fetches the order identifier and the order tracking number.

17. The computerized smart doorbell method of claim 16, wherein the order identifier and the order tracking number are transmitted from the delivery-side mobile device to the smart doorbell and a smart-door bell service management server-side system.
